(19) United States
(12) Patent Application Publication
(10) Pub. No.: US 2009/0103965 A1
(43) Pub. Date: Apr. 23, 2009

(54) WEB-FED PRINTING PRESS

(75) Inventors: Wolfgang RONECKER, Ehingen (DE); Peter SCHULMEISTER, Pfaffenhofen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/253,638

(22) Filed: Oct. 17, 2008

(30) Foreign Application Priority Data
Oct. 19, 2007 (DE) 10 2007 050 145.7

(51) Int. Cl. B41J 15/00

(52) U.S. Cl. 400/613

(57) ABSTRACT

A web-fed printing press is disclosed. The press having at least one printing unit for printing at least one printing substrate web, and having at least one processing device for processing the at least one printing substrate web, a control device for controlling the at least one processing device, and a fastening device for arranging the at least one processing device at an arbitrary web feed position between a reel changer of the web-fed printing press and an exit of a folding unit of the web-fed printing press in such a way that the at least one processing device is able to process the printing substrate web on an upper side and/or on a lower side and/or on one or both edges of the same.

This application claims the priority of German Patent Document No. 10 2007 050 145.7, filed Oct. 19, 2007, the disclosure of which is expressly incorporated by reference herein.

### BACKGROUND AND SUMMARY OF THE INVENTION

The invention relates to a web-fed printing press having at least one printing unit for printing at least one printing substrate web and having at least one processing device for processing the printing substrate web.

Web-fed printing presses, in particular newspaper and commercial web printing presses, have at least one and most of the time several printing units, in order to print at least one printing substrate web, in particular several printing substrate webs, on both sides. The offset printing process or the gravure printing process may be used, for example, for printing the printing substrate web(s). In this case, the printing substrate web(s) are printed conventionally with a static printed image that is therefore the same for all printed copies.

In the case of web-fed printing presses, there is an increasing need to print printing substrate webs not just conventionally, for example, by means of the offset printing process, but to convey the printing substrate webs to a further processing. In this case, it can be the printing-related individualization of printed copies via an inkjet printing device, for example. Additional types of processing, which come into consideration in addition to conventional printing of the printing substrate webs are, for example, gluing, coating, drying, cutting, punching or even perforating.

In the case of web-fed printing presses known from practice, processing devices, which are used to process printing substrate webs printed with the aid of offset printing units, are positioned downstream from a folding unit as viewed in the transport direction of the printing substrate webs, i.e., positioned where the production speed is slow.

The advantage of this in principle is that the processing or post-processing of printing substrate webs that are conventionally printed, for example by means of offset printing, is not coupled to the production speed of the printing units. However, a considerable disadvantage is that, downstream from a folding unit, all printed pages or all locations within a printed copy are no longer accessible for a processing.

As a result, there is the need to develop web-fed printing presses, in which the additional processing device(s) is/are arranged in such a way that the printing substrate web or each of the printing substrate webs is/are able to be processed both on its lower side as well as its upper side.

The invention is based on the objective of creating a web-fed printing press that is set up in such a way that one or more printing substrate web(s) to be conveyed through the web-fed printing press for printing are able to flexibly undergo a processing on each side of the printing substrate web(s).

According to the invention, a web-fed printing press has at least one printing unit for printing at least one printing substrate web, at least one processing device or several processing devices for processing the at least one printing substrate web, control means for controlling the processing device or the processing devices and fastening means, by means of which the processing device or the processing devices is/are arranged at an arbitrary web feed position between a reel changer of the web-fed printing press and an exit of a folding unit of the web-fed printing press in such a way that the processing device or the processing devices is/are able to process the printing substrate web or printing substrate webs on an upper side and/or on a lower side and/or on one or both edges of the same.

In other words, the at least one processing device or the several processing devices is/are able to be installed in the entire area of the web-fed printing press along the guidance of the printing substrate web(s).

According to the invention, the possibility is thus created of flexibly subjecting, with the aid of a processing device or several processing devices, one or more printing substrate web(s), which is/are conventionally printed with the aid of printing units, to an additional processing, wherein the printing substrate web(s) is/are able to be processed in the area of each side, i.e., on an upper side and/or on a lower side and/or on one or both edges. In other words, for example, each location of the printing substrate web(s) is able to be printed, resulting in a high level of flexibility during installation.

The processing device or processing devices do not have to be re-mounted within the web-fed printing press during a production change (although this is possible in accordance with the invention); in fact, the processing devices may remain at the same position in the web-fed printing press as viewed in the transport direction or web feed direction of the printing substrate web or the printing substrate webs. Processing the or each printing substrate web in addition to conventional printing, such as, for example, offset printing or gravure printing, is possible at full production speed.

The fastening means may have, for example, cross-beams, screw connectors, riveted joints, angle brackets, linear bearings, radial bearings, etc., like those with which the person skilled in the art, who is being addressed here, is familiar.

The control means may have one or more control device(s), which may be embodied in the form of hardware, in the form of software, or as a combination of hardware and software.

The processing devices should be understood in accordance with the invention such that they perform an additional processing that goes beyond the “normal” or conventional printing process, in which the printing substrate web(s) are printed with a static printed image that is therefore the same for all printed copies, i.e., they are auxiliary devices.

According to an embodiment, several different processing devices may be arranged at different web feed positions between the reel changer and the exit of the folding unit in such a way that the processing devices are able to process the printing substrate web or the printing substrate webs on an upper side and/or on a lower side and/or on one or both edges of the same.

According to an embodiment of the invention, the processing device or the processing devices is/are able to be arranged at least one web feed position, i.e., at a web feed position or at several web feed positions, from a web feed position directly after the reel changer, between the reel changer and one of the printing units, directly in a component of the web-fed printing press, such as in particular in a printing tower, between two printing units, between the printing units and a turner bar unit of the web-fed printing press, in the turner bar unit, between the turner bar unit and lead-in rollers of the web-fed printing press forming a harp, within the harp, in a folding unit superstructure of the web-fed printing press, such as in particular in a ribbon guide, in a folding unit upper section of the web-fed printing press or in the folding unit.

According to an embodiment of the invention, the processing device or the processing devices is/are able to have one or more of an auxiliary printing device, a gluing device, a coating device, a drying device, a foil transfer device, a cutting device, a punching device and a perforating device, wherein the invention should not be considered to be restricted to the cited processing devices.

According to an embodiment of the invention, the auxiliary printing device may be formed by an inkjet printing device.

The invention will be described in more detail in the following on the basis of exemplary embodiments and making reference to the figures.

### BRIEF DESCRIPTION OF THE DRAWINGS

FIG. 1 shows a front view of a rotary web offset newspaper printing press having several printing towers from 4+4 printing with two stacked 9-cylinder satellite printing units with vertical web guidance.

FIG. 2 shows a side view of the rotary web offset newspaper printing press from FIG. 1.

FIG. 3 shows, as a partial view of FIG. 1, one of the printing towers of the rotary web offset newspaper printing press from FIG. 1.

### DETAILED DESCRIPTION OF THE DRAWINGS

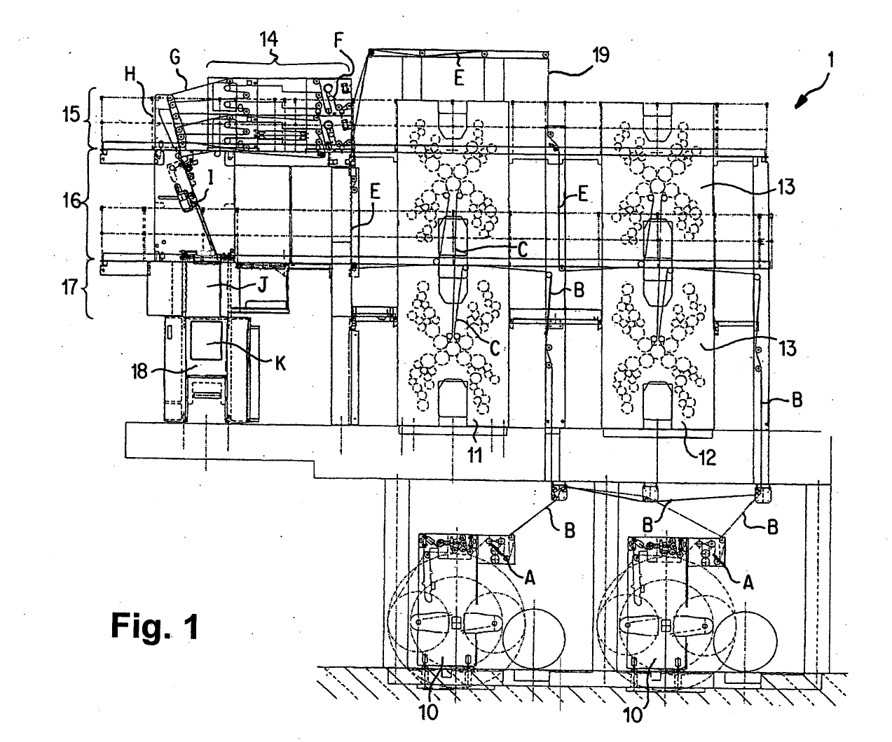

FIG. 1 shows a front view of a rotary web offset newspaper printing press (hereinafter printing press) 1, which has two reel changers 10 and 10, two printing towers 11, 12 from 4+4 printing, each of which has two stacked 9-cylinder satellite printing units (hereinafter printing units) 13 with vertical web guidance, a turner bar unit 14, lead-in rollers forming a harp 15, a folding unit superstructure 16, a folding unit upper section 17 and a folding unit 18.

Printing substrate webs 19 may be printed on both sides in the printing units 13 of the printing towers 11, 12. The printing substrate webs 19 to be printed in the printing towers 11, 12 are kept in readiness in the region of the reel changers 10, 10 and conveyed downstream from the printing towers 11, 12 to the folding unit 18 via the turner bar unit 14, the harp 15, the folding unit superstructure 16 and the folding unit upper section 17. The person skilled in the art, who is being addressed here, is familiar with the details of reel changers 10, turner bar units 14, lead-in rollers forming a harp 15, folding unit superstructures 16, folding unit upper sections 17 and folding units 18, and they require no further explanation.

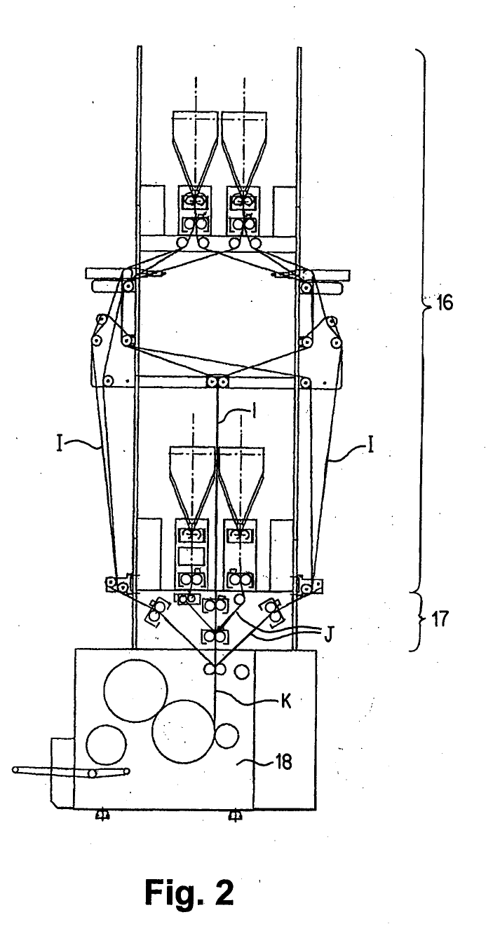

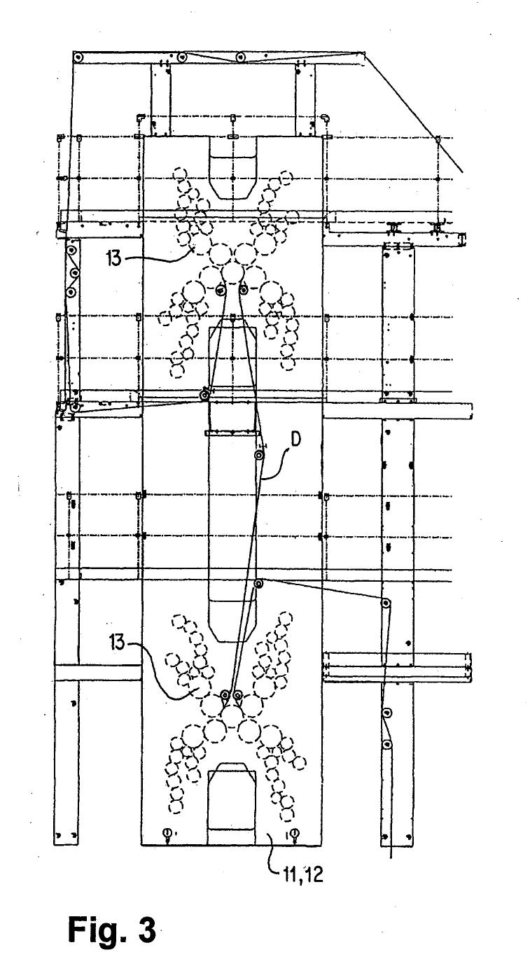

As indicated in FIGS. 1 through 3 only by means of corresponding web feed positions A through K, the printing press 1, according to an embodiment of the invention, has several processing devices for processing the printing substrate webs 19.

The processing devices are arranged in the printing press 1 by means of fastening devices (not shown), by means of which the respective processing devices are arranged at a respective arbitrary web feed position A through K between the reel changers 10 and an exit of the folding unit 18 in such a way that the processing devices are able to process the printing substrate webs 19 on an upper side and/or on a lower side and/or on one or both edges of the same.

According to an embodiment of the invention, a processing device in the form of an inkjet printing device is provided respectively at web feed positions E, which are located respectively on the route from one printing unit 13 to the turner bar unit 14. The inkjet printing devices each feature an inkjet printing head, which is arranged so that it is translatorily displaceable on a cross-beam mounted transverse to the transport direction of the respective printing substrate web 19 in an operating position with respect to the respective printing substrate web 19.

In other words, the inkjet printing head is adjustably mounted on the cross-beam so that its position is adjustable in the normal manner via a control signal made available by a control device (not shown) or also manually. The control device is furthermore used to activate the inkjet printing head so that the inkjet printing head is able to print individually adaptable image information on the respective printing substrate web 19.

According to an embodiment of the invention, a processing device in the form of a foil transfer device (not shown) is arranged at a web feed position G, which is located on the route from the turner bar unit 14 to the harp 15. The foil transfer device may also be used to apply, for example, adhesive stickers individualized for the printed product to one of the printing substrate webs 19. Of course, several foil transfer devices for processing several of the printing substrate webs 19 may also be provided according to a design of this embodiment of the invention.

To activate the foil transfer device(s), a control device (not shown) is again provided.

According to an embodiment of the invention, two processing devices in the form of a coating device and a drying device are arranged in succession at web feed positions B, which are located respectively on a route from one of the respective reel changers 10, 10 to one of the printing units 13. The coating device may be used, for example, to apply a decorative UV ink, i.e., an ink that is luminescent or visible under ultraviolet light, on the respective printing substrate web 19. Of course, other inks and other intended uses are also conceivable. The drying device may be used to dry the applied ink immediately upon application in order to prevent smearing of the ink.

To activate the coating device and the drying device, a control device (not shown) is again provided.

According to an embodiment of the invention, a processing device in the form of a punching device (not shown) is provided at a web feed position H, which is located in the harp 15. The punching device may be used to introduce decorative or functional punches into one of the printing substrate webs 19 or into several of the printing substrate webs 19.

To activate the punching device, a control device (not shown) is again provided.

According to an embodiment of the invention, a processing device in the form of a perforating device (not shown) is provided at a web feed position F, which is located in the turner bar unit 14. The perforating device may be used, for example, to introduce perforations into one of the printing substrate webs 19 or into several of the printing substrate webs 19, making it possible for a reader to tear out sections of pages from a finished printed product in a simple manner.

To activate the perforating device, a control device (not shown) is again provided.

According to an embodiment of the invention, a processing device in the form of a gluing device (not shown) is provided at a web feed position I, which is located in the folding unit superstructure 16 in the ribbon guide. The gluing device may be used to apply adhesive to one of the printing substrate webs 19 or to several of the printing substrate webs 19 so that, for example, specific pages on the printed product spine or on the fold are connected or glued to one another in the finished printed product.

To activate the gluing device, a control device (not shown) is again provided.

According to an embodiment of the invention, a processing device in the form of a cutting device (not shown) is provided at a web feed position J, which is located in the folding unit upper section 17. The cutting device may be used to introduce cuts in one of the printing substrate webs 19 or in several of the printing substrate webs 19, wherein, for example, sections of pages of a printed product may be cut off in a targeted manner or connected pages of a printed product may be separated.

To activate the cutting device, a control device (not shown) is again provided.

According to an embodiment of the invention, a processing device in the form of a punching device (not shown) is provided at a web feed position K, which is located in the folding unit 18. The punching device may be used to introduce decorative or functional punches in one of the printing substrate webs 19 or in several of the printing substrate webs 19.

To activate the punching device, a control device (not shown) is again provided.

According to additional embodiments of the invention, a processing device in the form of an inkjet printing device (not shown) is provided at web feed positions A, which are respectively located directly after one of the reel changers 10, or at web feed positions C, which are located directly in the respective printing towers 11, 12, or at web feed positions D, which are respectively located between two printing units 13 of the respective printing towers 11, 12. The inkjet printing device may be used to imprint individually adaptable image information on one of the printing substrate webs 19 or on several of the printing substrate webs 19.

To activate the inkjet printing device, a control device (not shown) is again provided.

According to other embodiments of the invention, each of the cited processing devices may also be provided singly or several-fold at each of the other of the cited web feed positions A through K.

In summary, the printing press 1 according to the invention may have one or more processing devices, which is/are arranged at a web feed position or at several web feed positions at a web feed position A directly after a reel changer 10, a web feed position B between a reel changer 10 and a printing unit 13, a web feed position C directly in a component of the printing press 1, such as in particular in a printing tower 11, 12, a web feed position D between two printing units 13, a web feed position E between a printing unit 13 and a turner bar unit 14, a web feed position F in the turner bar unit 14, a web feed position G between the turner bar unit 14 and lead-in rollers forming a harp 15, a web feed position H within the harp 15, a web feed position I in a folding unit superstructure 16, such as in particular in a ribbon guide, a web feed position J in a folding unit upper section 17 and a web feed position K in the folding unit 18.

According to the invention, the processing devices may be embodied in the form of one or more of an auxiliary printing device, such as in particular an inkjet printing device, a gluing device, a coating device, a drying device, a foil transfer device, a cutting device, a punching device and a perforating device, wherein the invention should not be considered as being restricted to the cited processing devices.

### LIST OF REFERENCE NUMBERS

1 Web-fed printing press (printing press)
10 Reel changer
11 Printing tower
12 Printing tower
13 Printing unit(s)
14 Turner bar unit
15 Harp/lead-in rollers
16 Folding unit superstructure
17 Folding unit upper section
18 Folding unit
19 Printing substrate web(s)
A Web feed position directly after a reel changer
B Web feed position between reel changer and printing unit
C Web feed position directly in a component such as the printing tower
D Web feed position between two printing units
E Web feed position between printing unit and turner bar unit
F Web feed position in the turner bar unit
G Web feed position between turner bar unit and harp/lead-in rollers
H Web feed position in the harp
I Web feed position in folding unit superstructure
J Web feed position in folding unit upper section
K Web feed position in folding unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed printing press, comprising at least one printing unit for printing at least one printing substrate web, at least one processing device for processing the at least one printing substrate web, a control device for controlling the at least one processing device, and a fastening device which arranges the at least one processing device at a web feed position between a reel changer of the web-fed printing press and an exit of a folding unit of the web-fed printing press such that the at least one processing device is able to process the at least one printing substrate web on an upper side and/or on a lower side and/or on one or both edges of the at least one printing substrate web.

2. The web-fed printing press according to claim 1, wherein the web feed position is directly after the reel changer, or is between the reel changer and the at least one printing unit, or is between the at least one printing unit and a turner bar unit of the web-fed printing press, or is in the turner bar unit, or is between the turner bar unit and lead-in rollers of the web-fed printing press forming a harp, or is within the harp, or is in a folding unit superstructure of the web-fed printing press, or is in a folding unit upper section of the web-fed printing press, or is in a folding unit.

3. The web-fed printing press according to claim 1, wherein the web-fed printing press has at least two printing units and wherein the web feed position is directly after the reel changer, or is between the reel changer and one of the at least two printing units, or is directly in a printing tower, or is between the at least two printing units, or is between the at least two printing units and a turner bar unit of the web-fed printing press, or is in the turner bar unit, or is between the turner bar unit and lead-in rollers of the web-fed printing press forming a harp, or is within the harp, or is in a folding unit superstructure of the web-fed printing press, or is in a folding unit upper section of the web-fed printing press, or is in a folding unit.

4. The web-fed printing press according to claim 1, wherein the at least one processing device is an auxiliary printing device, or a gluing device, or a coating device, or a drying device, or a foil transfer device, or a cutting device, or a punching device, or a perforating device.

5. The web-fed printing press according to claim 4, wherein the auxiliary printing device is an inkjet printing device.

6. A web-fed printing press, comprising at least one printing unit for printing at least one printing substrate web, several processing devices for processing the at least one printing substrate web, a control device for controlling the processing devices, and fastening devices which arrange respective processing devices at a respective web feed position between a reel changer of the web-fed printing press and an exit of a folding unit of the web-fed printing press such that the processing devices are able to process the at least one printing substrate web on an upper side and/or on a lower side and/or on one or both edges of the at least one printing substrate web.

7. The web-fed printing press according to claim 6, wherein the respective web feed position is directly after the reel changer, or is between the reel changer and the at least one printing unit, or is between the at least one printing unit and a turner bar unit of the web-fed printing press, or is in the turner bar unit, or is between the turner bar unit and lead-in rollers of the web-fed printing press forming a harp, or is within the harp, or is in a folding unit superstructure of the web-fed printing press, or is in a folding unit upper section of the web-fed printing press, or is in a folding unit.

8. The web-fed printing press according to claim 6, wherein the web-fed printing press has at least two printing units and wherein the respective web feed position is directly after the reel changer, or is between the reel changer and one of the at least two printing units, or is directly in a printing tower, or is between the at least two printing units, or is between the at least two printing units and a turner bar unit of the web-fed printing press, or is in the turner bar unit, or is between the turner bar unit and lead-in rollers of the web-fed printing press forming a harp, or is within the harp, or is in a folding unit superstructure of the web-fed printing press, or is in a folding unit upper section of the web-fed printing press, or is in a folding unit.

9. The web-fed printing press according to claim 6, wherein the processing devices are each one of an auxiliary printing device, or a gluing device, or a coating device, or a drying device, or a foil transfer device, or a cutting device, or a punching device, or a perforating device.

10. The web-fed printing press according to claim 9, wherein the auxiliary printing device is an inkjet printing device.
